(19) United States
(12) Patent Application Publication
(10) Pub. No.: US 2016/0318200 A1
(43) Pub. Date: Nov. 3, 2016

(54) MODULAR KNIFE SHEATH SYSTEMS

(71) Applicant: GTG Knives, LLC, Summerville, SC (US)

(72) Inventor: Robert Wright, Summerville, SC (US)

(73) Assignee: GTG KNIVES, LLC, Summerville, SC (US)

(21) Appl. No.: 14/698,886

(22) Filed: Apr. 29, 2015

(51) Int. Cl. B26B 29/02; A45F 5/02; B26B 3/00

(52) U.S. Cl. CPC B26B 29/025; B26B 3/00; A45F 5/021

(57) ABSTRACT

Systems and methods for carrying a bladed tool affixed to a person employ a sheath member, a concealment member, and a carrying member that are reversibly coupled together. Such systems and methods allow a person to customize the manner in which the bladed tool is carried. Law enforcement officers, emergency response personnel, soldiers, and others can employ those systems and methods.

### FIELD OF INVENTION

This invention relates to sheaths for tools such as knives and other bladed tools.

### BACKGROUND OF THE INVENTION

Law enforcement officers, emergency response personnel, soldiers, park rangers, handymen, and others often require a bladed tool such as a knife to be carried in a secure manner on their persons. It is desirable that the bladed tool remains securely fastened, yet easily accessible, even with one-handed operation to deploy it. However, it is disadvantageous if the handle of the bladed tool jabs the wearer, snags on clothing or the environment through which the wearer moves, or presents a ready grip for an attacker. Also, it is often desirable to partially or completely conceal the bladed tool, so that its presence on the wearer's person does not unnecessarily magnify the aggressive appearance of the wearer.

It is also desirable for a person requiring a bladed tool to configure how that tool will be carried. The wearer may be right-handed or left-handed, and may prefer to carry the tool on a belt or on a tactical vest. Accordingly, a modular sheath system that can be readily arranged by the wearer into various configurations would be very useful.

Unexpectedly, the applicant has discovered several inventive modular sheath systems useful for carrying tools such as a bladed tool on a person.

### SUMMARY OF THE INVENTION

Some embodiments of the present invention therefore relate to systems for carrying a bladed tool affixed to a person, comprising a sheath member, a concealment member, and a carrying member; wherein the sheath member, the concealment member, and the carrying member are adapted to be reversibly coupled by one or more connection members.

Other embodiments of the present invention relate to methods of carrying a bladed tool affixed to a person, comprising reversibly coupling a sheath member, a concealment member, and a carrying member by one or more connection members; affixing the carrying member to the person; and placing the bladed tool in the sheath member.

Further embodiments relate to methods of making
a system for carrying a bladed tool affixed to a person, the system comprising a sheath member, a concealment member, and a carrying member; wherein the sheath member, the concealment member, and the carrying member are adapted to be reversibly coupled by one or more connection members;
the methods comprising manufacturing one or more of the sheath member, the concealment member, and the carrying member.

While the disclosure provides certain specific embodiments, the invention is not limited to those embodiments. A person of ordinary skill will appreciate from the description herein that modifications can be made to the described embodiments and therefore that the specification is broader in scope than the described embodiments. All examples are therefore non-limiting.

### BRIEF DESCRIPTION OF THE DRAWINGS

FIG. 1 is an exploded, elevational view of a modular system according to one aspect of the disclosure;

FIG. 2 is a plan view of some components of the system as in FIG. 1;

FIGS. 3A, 3B, and 3C are front and rear plan views and an end view of the system as in FIG. 2;

FIGS. 4A and 4B are front and rear plan views of the system as in FIG. 1 in an intended use environment;

FIG. 5 is a perspective view of a modular system being assembled according to another aspect of the disclosure;

FIGS. 6A and 6B are front and rear plan views of the system as in FIG. 5 in an intended use environment;

FIG. 7 is a perspective view of the modular system as in FIG. 5 being assembled according to another aspect of the disclosure;

FIG. 8 is an elevational view of the modular system as in FIG. 7 shown partially in phantom for clarity in an intended use environment;

FIG. 9 is an elevational view of the modular system as in FIG. 7 shown partially in phantom for clarity in another intended use environment;

FIG. 10 includes front and rear perspective views of a modular system according to a further aspect of the disclosure;

FIG. 11 includes side, front and rear elevational views and top and bottom plan views of the tool introduced in FIG. 1; and

FIG. 12 includes side, front and rear elevational views and top and bottom plan views of another tool according to another aspect of the disclosure.

### DETAILED DESCRIPTION

As required, detailed embodiments of the present invention are disclosed herein; however, it is to be understood that the disclosed embodiments are merely exemplary of the invention that may be embodied in various forms. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that don't negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Any discussion of the prior art throughout the specification should in no way be considered as an admission that such prior art is widely known or forms part of common general knowledge in the field.

It is an object of the present invention to overcome or ameliorate at least one of the disadvantages of the prior art, or to provide a useful alternative.

As stated before, some embodiments of the present invention relate to systems for carrying a bladed tool affixed to a person. A bladed tool is affixed to a person when, for example, the tool is securely attached to clothing or equipment worn by the person. That clothing or equipment can include, but is not limited to shirts, jackets, pants, uniforms, coveralls, harnesses, belts, utility belts, tool belts, vests, tactical vests, ballistic vests, or any suitable garment adapted to be worn by a person. In some cases, systems can be affixed to equipment that is carried by or strapped to a person, such as, for example, a gear bag, a dive bag, a first aid kit, a backpack, or the like. Certain cases allow for the person to easily and single-handedly retrieve the bladed tool from the system. Other cases allow for the system to partially or completely conceal the bladed tool. Still other cases allow for the system to comfortably protect the body of the person from contacting the handle of the bladed tool while affixed to the person.

Certain embodiments comprise a sheath member. A sheath member is adapted to partially or completely enclose the blade portion of a bladed tool, and can be made from any suitable material. Leather, fabric such as nylon, metals, and plastics, among others, and combinations thereof, can be used for the sheath member. In some cases, the sheath member comprises a moldable thermoplastic. In certain of those cases, the moldable thermoplastic comprises an acrylic-polyvinyl chloride composite. Among acrylic-polyvinyl chloride composites, the brand name Kydex® may be mentioned. Among nylon fabrics, Cordura® nylon may be mentioned.

A sheath member can be made in any suitable manner. If a moldable thermoplastic is used, the thermoplastic can be heated and contacted with the bladed tool so that the sheath member substantially conforms to a shape of the bladed tool. Certain instances of the present invention provide a sheath member that comprises a plurality of eyelet rivets adapted to receive the one or more connection members. In some cases, the plurality of eyelet rivets is disposed along an outer edge of the sheath member.

Any suitable connection members can be used. Suitable connection members include, but are not limited to, screws, bolts with nuts, snaps, cord, hook and loop fabrics, and combinations thereof. Hook and loop fabrics include, for example, fabrics sold under the trademark Velcro®. Suitable connection members include those adapted to allow a person to reversibly couple the various members of the system together in one or more configurations. In this way, the sheath member, the concealment member, and the carrying member are adapted to be reversibly coupled by one or more connection members. In a first configuration, the concealment member is positioned relative to the handle of the bladed tool so as to substantially conceal the bladed tool. In such a configuration, the handle of the bladed tool is closer to the body of the person wearing the system than the concealment member. Thus, the concealment member is adapted to substantially conceal the bladed tool in a first configuration. The first configuration may reduce potential contact between the handle of the bladed tool with clothing and the environment through which the person moves, in certain embodiments. In a second configuration, the concealment member is positioned relative to the handle of the bladed tool so as to protect the body of the person from contact with the handle. In such a configuration, the concealment member is closer to the body of the person wearing the system than the handle of the bladed tool, and improves the comfort of the person but may not conceal the bladed tool. In the second configuration, the concealment member is adapted to separate the bladed tool from the body of the person. Still additional embodiments provide a system comprising a sheath member, a first concealment member configured to substantially conceal a tool being carried in the sheath member, a second concealment member configured to interpose between the tool and the body of the person wearing the system, and a carrying member.

Further embodiments of the present invention allow the carrying of a bladed tool in any suitable alignment. In certain instances, the system is adapted to carry the bladed tool in a substantially vertical alignment. A substantially vertical alignment is achieved when the longest dimension of the bladed tool is approximately parallel to the spine of the person carrying the tool. In other words, the handle of the tool is “up” or “down” relative to the person. In other instances, the system is adapted to carry the bladed tool in a substantially horizontal alignment. A substantially horizontal alignment is achieved when the longest dimension of the bladed tool is approximately perpendicular to a plane comprising the spine of the person carrying the tool. In other words, the handle of the tool is “sideways” relative to the person. Those alignments apply whether the bladed tool is carried on the torso or on a limb of the person, and are measured when the person is standing up with his arms at his side.

Utility belts worn by law enforcement officers are often configured to include one or more magazine pouches suitable for carrying extra clips of ammunition for the officers' service handgun. The magazine pouches may provide a suitable location for certain systems of the present invention. Accordingly, particular embodiments provide a system adapted to affix to a utility belt behind the magazine pouches. Such systems are adapted to be disposed between the magazine pouches and the utility belt, and can be disposed in any suitable alignment and configuration. In some cases, the system is adapted to carry the bladed tool in a substantially vertical alignment behind the magazine pouches. In other cases, the system is adapted to carry the bladed tool in a substantially horizontal alignment behind the magazine pouches. In further cases, the system is adapted to carry the bladed tool in a first configuration behind the magazine pouches. In still further cases, the system is adapted to carry the bladed tool in a second configuration behind the magazine pouches.

Further embodiments of the present invention include a concealment member. The concealment member can be made of any suitable material, such as, for example, leather, nylon, or a combination thereof. In some cases, the concealment member comprises 4 to 5 ounce leather. In further cases, the concealment member comprises leather having a surface pattern chosen from plain, basketweave, or a combination thereof, over at least a portion of a surface of the concealment member. A concealment member can have any suitable shape. For example, a concealment member can have a shape that loosely conforms to the silhouette of the handle of the bladed tool. A concealment member can be smaller than, the same size as, or larger than the handle of the bladed tool. Some instances provide a concealment member having a substantially rectilinear form. Other instances provide a concealment member having a substantially oval form. Still other instances provide a concealment member having a shape that is unrelated to the silhouette of the handle of the bladed tool. For example, certain instances provide a concealment member having a substantially circular form. In some cases, the concealment member is about 2″× about 7″. In other cases, the concealment member is about 3″× about 7″.

Often, tactical vests, ballistic vests, backpacks, and other clothing and equipment include webbing comprising one or more strips of nylon or other sturdy fabric sewn to the article so that a variety of items can be attached to the article. Optionally, loop fabric separates and/or covers the strips, so that hook fabric also can be used. Various types of webbing are known such as the pouch attachment ladder system (“PALS”) webbing that carries modular lightweight load-carrying equipment (“MOLLE”). Certain embodiments of the present invention are adapted to be used with such articles. Any suitable carrying members for attaching systems of the present invention to such webbing can be used. The carrying members described below, including modular attachment devices, may be mentioned. Optionally, a concealment member can further comprise one or more tabs, a fringe extending partially or fully around the edges, or a combination thereof having a hook fabric adapted to couple with a loop fabric disposed on a tactical vest or other piece of clothing or equipment. In this way, the hook fabric further secures the concealment member to the tactical vest via contact with the loop fabric. Alternatively, the hook fabric can appear on the vest with the loop fabric appearing on the tabs and/or fringe of the concealment member, or combinations of hook fabric and loop fabric can be disposed as the skilled artisan desires. In an alternative embodiment, the concealment member itself comprises hook fabric, loop fabric, or both. In a further embodiment, one or more tabs, fringe, and/or concealment member comprises one or more magnets. Those magnets can couple to magnets or metal associated with the surface to which the system is affixed, the bladed tool, or both. The tabs, fringe, or a combination thereof can be formed by any suitable method. They can form part of the same piece of material as the concealment member; or they can form one or more separate pieces of material permanently or reversibly attached to the concealment member. In one case, a plurality of tabs is formed from a single piece of material that is affixed to the concealment member via hook and loop fabrics.

The concealment member can be adapted to reversibly couple to the other members of the system by any suitable means. Some embodiments provide a concealment member that comprises two holes adapted to align with at least two eyelet rivets of the sheath member. In other cases, the concealment member comprises at least two eyelet rivets, and the sheath member comprises at least two holes adapted to align with at least two eyelet rivets on the concealment member. In still other cases, the carrying member comprises the eyelet rivets, and the remaining members have appropriate holes to align with those eyelet rivets. In further cases, one or more eyelet rivets are replaced by one or more threaded screw posts, in any of those embodiments in which eyelet rivets are described herein.

Additional embodiments of the present invention provide a carrying member. A carrying member can be made of any suitable material, such as, for example wood, leather, plastic, fabric, and combinations thereof. In some cases, the carrying member comprises two holes adapted to align with at least two eyelet rivets of the sheath member. In still other cases, the carrying member comprises a belt clip affixed to a mounting piece. The mounting piece in such cases can be made of any suitable material such as, for example, wood, leather, plastic, fabric, and combinations thereof. In some examples, the mounting piece is rigid, while in other examples, the mounting piece is flexible. In still other embodiments, the carrying member comprises a flexible strap comprising at least one reversible attachment device. Suitable reversible attachment devices are not limited. Some embodiments provide at least one reversible attachment device chosen from snaps, buttons, hook-and-loop fabrics, magnets, and combinations thereof. In other cases, a carrying member comprises a modular attachment device.

Among modular attachment devices, several may be mentioned. Malice Clip® brand binder clips, such as those described in U.S. Pat. No. 6,823,566, can be used. Alternatively, Tek-Lok™ brand devices, such as those described in U.S. Pat. No. 6,145,169, can be used. The foregoing '566 and '169 patents are hereby incorporated herein by reference in their entirety. Certain embodiments of the present invention provide the several members having at least two holes that align with holes on a modular attachment device for ease in reversibly coupling together.

Various embodiments of the present invention can be used to carry any suitable tool. In some embodiments, the tool is a bladed tool. In other embodiments, the bladed tool comprises a knife blade. Further embodiments provide a bladed tool comprising a glass breaker. In still further embodiments, the bladed tool comprises a seatbelt cutter. Suitable tools include those comprising one or more functional attributes, such as, for example, a bladed tool comprising a knife blade and a bottle opener.

Further embodiments of the present invention provide methods of making a system for carrying a bladed tool affixed to a person. Any suitable methods of making one or more components of the systems can be used. Weaving, sewing, screwing, bolting, blow molding, cutting, stamping, and other methods known to the skilled artisan can be employed.

Yet additional embodiments provide methods of using a system for carrying a bladed tool affixed to a person comprising:
reversibly coupling a sheath member, a concealment member, and a carrying member by one or more connection members;
affixing the carrying member to the person; and placing the bladed tool in the sheath member.

### DETAILED DESCRIPTION OF THE DRAWINGS

Further embodiments of the present invention can be described by reference to the accompanying drawings.

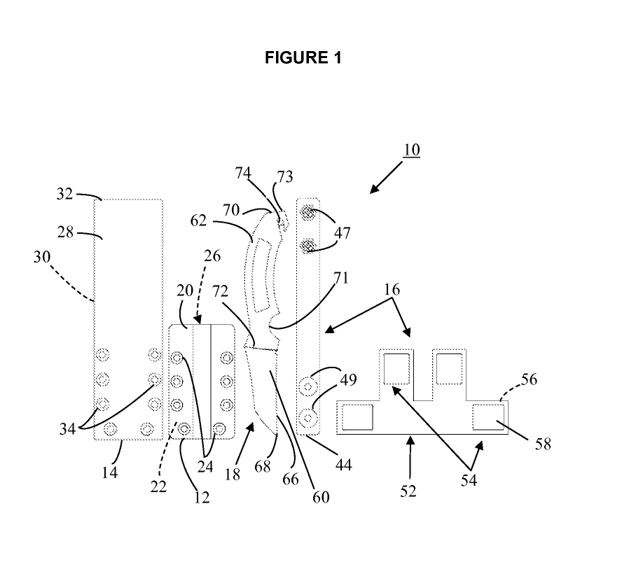

FIG. 1 shows, according to an embodiment of the disclosure, a modular knife or tool holding system designated in general by the number 10. The modular knife holding system 10 may broadly include a sheath member or sheath 12, a concealment member 14, a carrying device or member 16. Also shown is a tool 18 that can be used with system 10. As shown, the sheath member 12 may have a first side or face 20 and an opposing second side or face 22. One or more screws, bolts with nuts, snaps, cord, or other connection members may be attached or connected on or through eyelet rivets 24 on the sheath member 12 for connection to the concealment member 14 via eyelet rivets 34. More specifically, the concealment member 14 in this example has a rectilinear shape and includes a first side or face 28, an opposing second side or face 30, and a distal end or edge 32. One or more screws, bolts with nuts, snaps, cord, or other connection members may be attached or connected on or through eyelet rivets 34 on concealment member 14 for connection to the sheath member 12. As briefly introduced above, the connection members assembling the system 10 via eyelet rivets 24, 34 may be reversible and various combinations of screws, bolts with nuts, snaps, cord, hook and loop fabrics, magnets and the like may be used with the sheath member 12 and the concealment member 14. FIG. 1 shows a plurality of eyelet rivets 24 disposed along an outer edge of the sheath member 12. FIG. 1 also shows the concealment member 14 comprises two holes (occupied by eyelet rivets 34) adapted to align with at least two eyelet rivets 24 of the sheath member 12.

FIG. 1 also shows that the sheath member 12 may include a pocket or sleeve 26 formed therein for receiving at least a portion of the tool 18, which in this example may be a blade 60 having a cutting edge 66 with a tip or point 68. Additionally, or alternatively, when the sheath member 12 and the concealment member 14 are connected, the pocket 26 may be formed therebetween. The pocket 26 will conceal the blade 60 as well as protect a user from being injured by the blade 60 while wearing the system 10.

A carrying member 16 shown in FIG. 1 may be reversible belt keeper 44, a MOLLE-type tab assembly 52 and combinations of these and other alternatives described in further detail below. Reversible belt keeper 44 shows connection members being screws 47 that fit into threaded receivers 49. In this manner, the sheath member 12, the concealment member 14, and the carrying member 16 (reversible belt keeper 44) are adapted to be reversibly coupled by one or more connection members 47. As shown here, the assembly 52 may include one or more hook-and-loop assemblies 54 having a loop or female side 56 and a hook or male side 58. The sides 56, 58 will be interchangeable to meet user requirements or preferences. Exemplary operations of the reversible belt keeper 44, the tab assembly 52 and other carrying members 16 are discussed below.

As further shown in FIG. 1, the tool 18 will be relatively flat to promote its concealment, as will be described in greater detail below. Moreover, the tool 18 may have a handle or grip 62 with a distal end 70 and a proximal end 72. Finger grip 71 aids a user in gripping tool 18 by the handle 62. The distal end 70 may be hidden by the edge 32 of the concealment member 14 in certain configurations of system 10. As shown, an overall length of the tool 18 may be no more than a height or length of the concealment member 14 such that the distal end 70 terminates at or near the edge 32 to help conceal the tool 18. Although the bladed tool 18 includes a blade 60 in this example, the tool 18 also may be employed to break glass, for instance, by using glass breaker 73 at the distal end 70 to rap or knock against a window to break it in an emergency. The tool 18 may also include a seatbelt cutter 74 as further shown and discussed below. Additional attributes of the bladed tool 18 include, but are not limited to, use as a bottle opener, a hammer, and a pick.

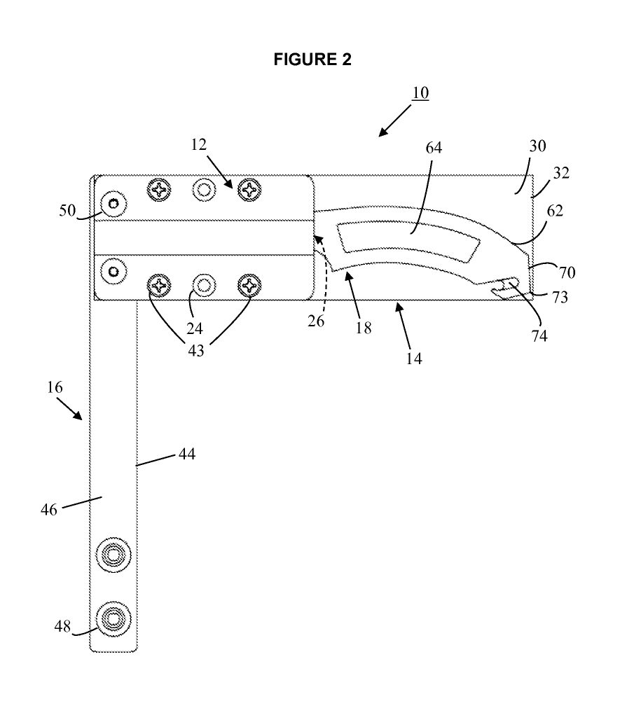

Turning now to FIG. 2, the modular tool holding system 10 is shown in horizontal orientation with the carrying member 16 being the reversible belt keeper 44 shown in an open position. As noted above and shown assembled here, the sheath member 12 is mated to the concealment member 14 by way of one or more connection members 43 (here, screws) through eyelet rivets 24. The sheath member 12 may include additional connection members such as snap caps 50 for connection with snap studs 48 or other compatible connection members of a strap 46 of the reversible belt keeper 44. Again, the connection members 43, 48, and 50 may be reversible, or they may be provided in an alternating arrangement on the sheath member 12 and the reversible belt keeper 44.

FIG. 2 also shows that the blade 60 in FIG. 1 is stored within the pocket 26 in the sheath member 12 or the pocket 26 formed between the sheath member 12 and the inner face 30 of the concealment member 14. Here, the handle 62 of the tool 18 includes a gripping feature or surface 64 which may be a concave feature, indentation, or trough to reduce surface contact area to permit better handing in moist conditions. Alternatively, or additionally, the surface 64 may include a wicking area or other material to absorb moisture. In yet another alternative, area 64 could define a void operable as a bottle opener.

As briefly introduced above, the handle 62 shown in FIG. 2 also may include the relatively flat end 70 that terminates at or near the edge 32 of the sheath backing 14 to conceal the tool 18. Also proximate the end 70 is the cutter 74, which may be used to cut a seat-belt, for instance, of a trapped motorist.

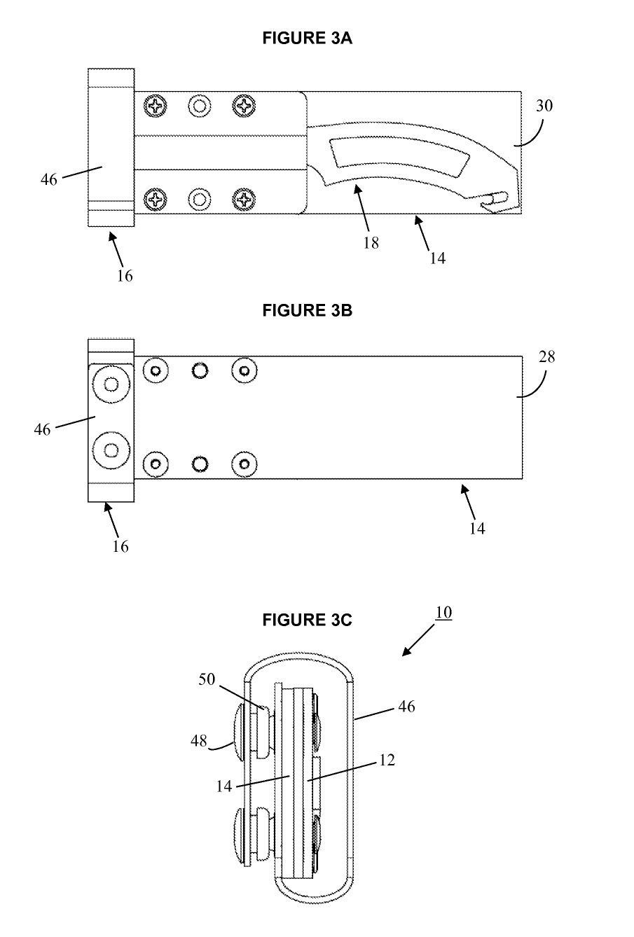

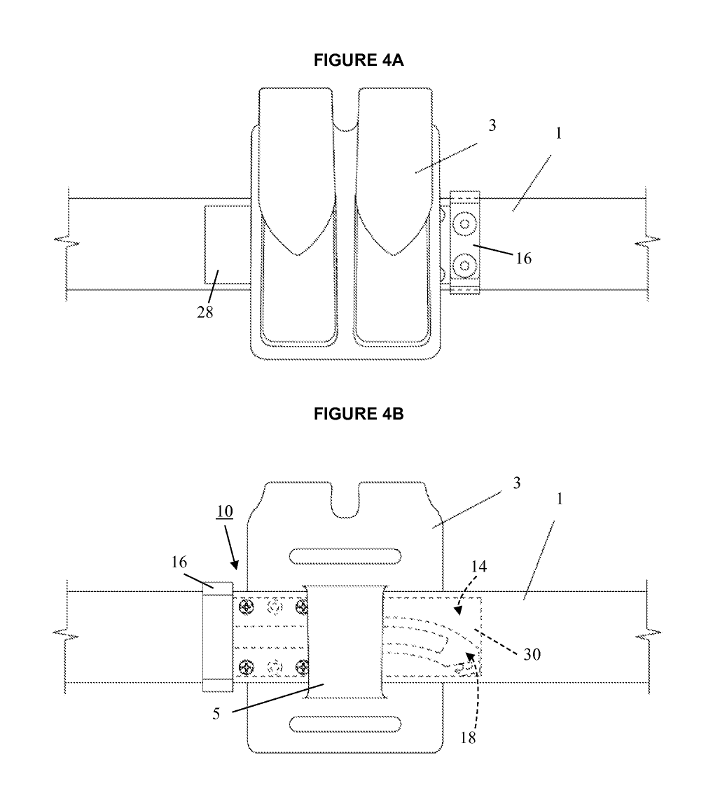

With reference to FIGS. 3A, 3B and 3C, the strap 46 is wrapped around sides 28, 30 of the concealment member 14 and snapped into position with the connection members 48, 50. As shown most clearly in FIG. 3C, the assembled tool system 10 is compact and relatively flat for wear upon a user, as described below with respect to FIGS. 4A and 4B.

FIGS. 4A and 4B show the modular tool system 10 attached to a belt 1 located substantially behind a magazine pouch 3. In FIG. 4A, for instance, portions of the carrying member 16 and the first face 28 of the concealment member 14 may be seen from an outer perspective. As introduced above, the face 28 may have a surface pattern that is plain, basketweave, and other patterns and combinations such as to blend with the belt 1. Viewed from a side of the belt 1 facing a body of the user, in FIG. 4B, a portion of the second face 30 of the concealment member 14 is seen in phantom between the magazine pouch 3 and the belt 1. A belt loop 5 secures the magazine pouch 3 to the belt 1. The bladed tool 18 is shown here in phantom for clarity but is concealed behind both the concealment member 14 and the magazine pouch 3 such that an outside viewer would likely not notice and be aware of the tool 18.

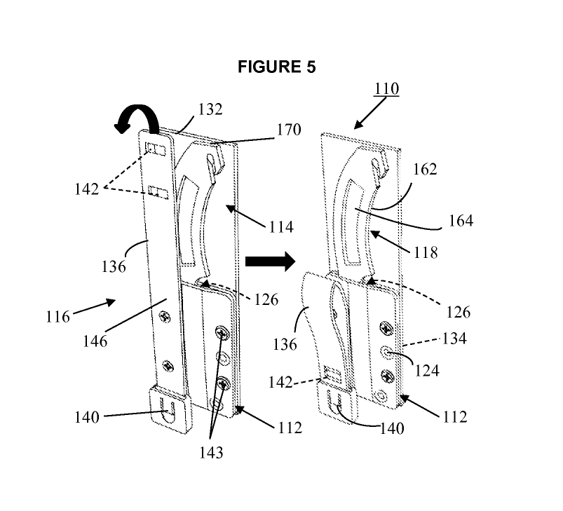

Turning to FIG. 5, another embodiment of a multipurpose, modular tool system is designated in general by element number 110. Here, a sheath member 112 is shown connected, attached or mated to a sheath backing or concealment member 114 using connection members 143 such as rivets, screws, hook and loop fasteners and the like via eyelet rivets 124, 134. A cutting or breaking tool 118 is stored in a pocket or sleeve 126 within the sheath member 112 or formed between the sheath member 112 and the concealment member 114. The tool 118 may include a handle 162 defining a void 164 and a terminal end 170 that is relatively concealed by an end 132 of the concealment member 114 to hide the tool 118.

FIG. 5 further shows a carrying member 116 that may be a tactical Malice Clip® 136. The clip 136 may include a strap 146 having one or more slots, notches, or openings 142 and a compatible locking tab 140. As shown by the bold curved arrow, the openings 142 may be wrapped or bent toward the tab 140. As shown by the bold, right hand arrow, this action forms a loop in the clip 136 and a desired notch within openings 142 is snapped into the locking tab 140.

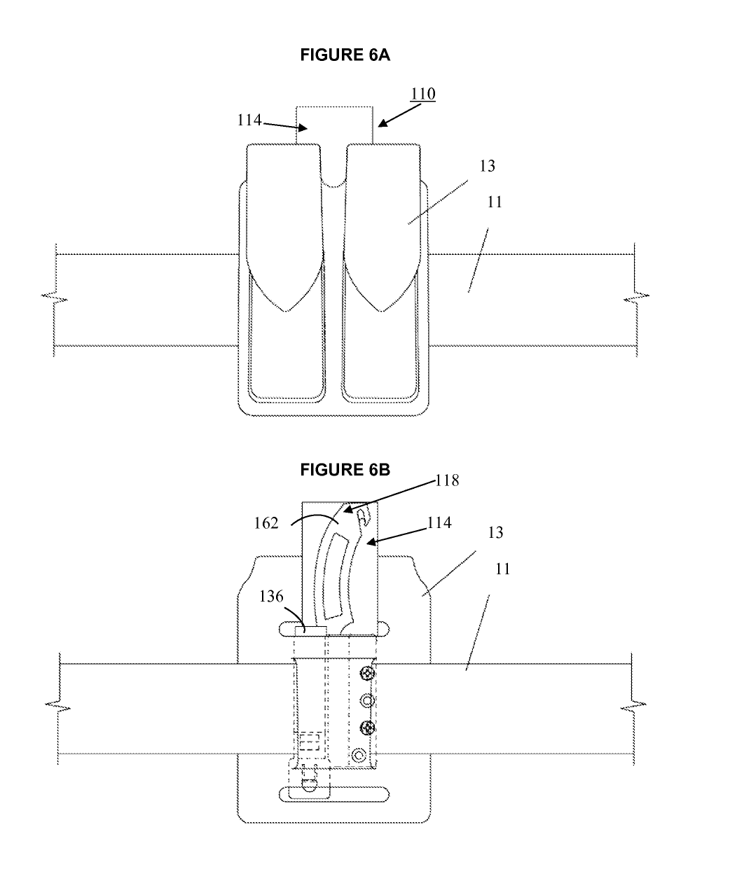

In FIG. 6A and 6B, the modular tool system 110 attached to a belt 11 located substantially behind a magazine pouch 13. In FIG. 6A, for instance, a portion the concealment member 114 in a substantially vertical alignment may be seen from a viewer's perspective. From a side of the belt 11 facing a body of a user, seen in FIG. 6B, a portion of the concealment member 114 is contained or secured behind a part of the belt 11 attached by the clip 136 (shown partially in phantom for clarity). Also shown, a handle 162 of the tool 118 is concealed behind both the concealment member 114 and the magazine pouch 13 such that an outside viewer would not see and be aware of the tool 118.

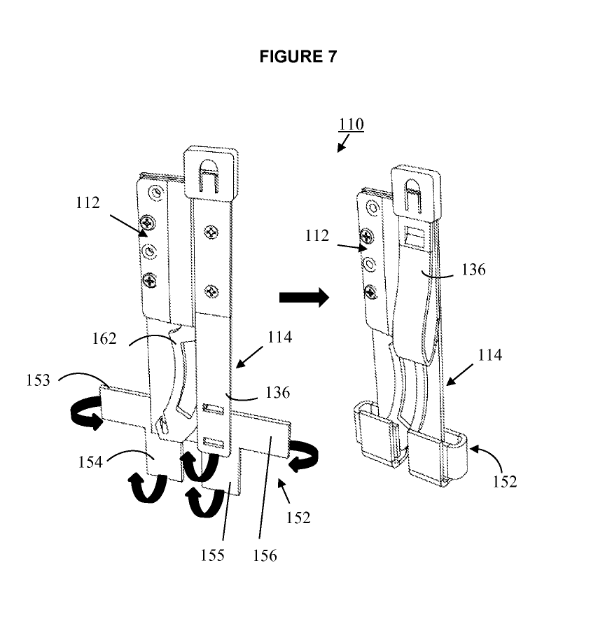

With reference to both FIG. 6B and 7, the modular tool system 110 may further include a tab assembly 152 that includes tabs 153, 154, 155, and 156 that each contain a properly-oriented button magnet. As shown by the curved arrows, the tab assembly 152 may be attached to or folded about a portion of the handle 162 and the concealment member 114 by folding tab 154 to meet tab 153, and tab 155 to meet tab 156. The folded configuration is shown by the right-handed arrow. As can be appreciated, the magnets in each tab would be properly oriented (north pole to south pole) so as to close tab assembly 152 as shown in the right side of FIG. 7.

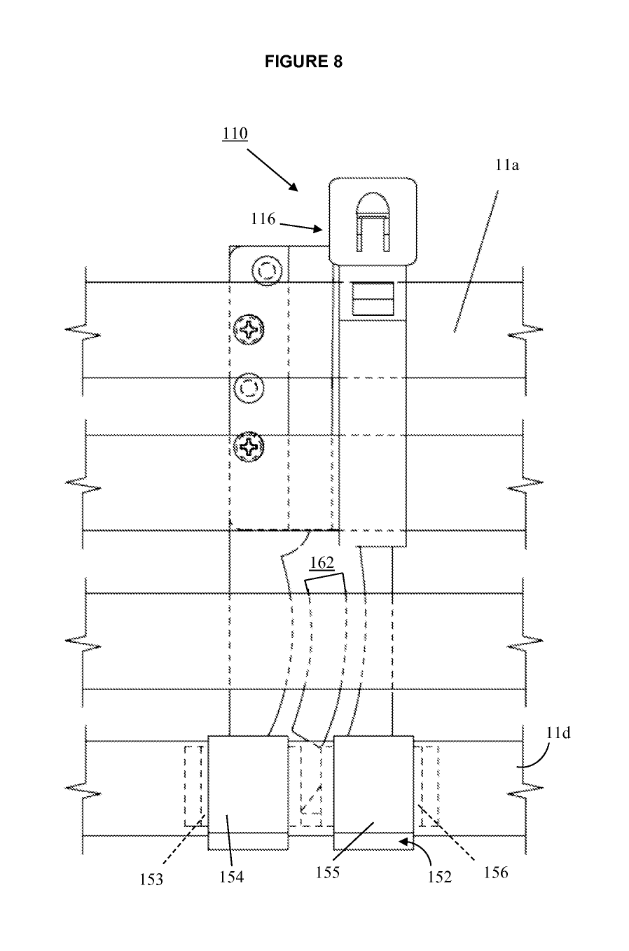

FIG. 8 shows the modular tool system 110 in a vertical alignment attached to MOLLE-compatible webbing having belts 11a and 11d in which the carrying member 116 is attached or wrapped about a portion of the belt 11a. Here, the tab assembly 152 is also connected to a portion of the belt 11d to both further conceal the handle 162 and to secure the system 110 to the belt 11. Tabs 154, 155 wrap around belt 11d and magnetically engage tabs 153, 156, respectively, through the fabric of belt 11d.

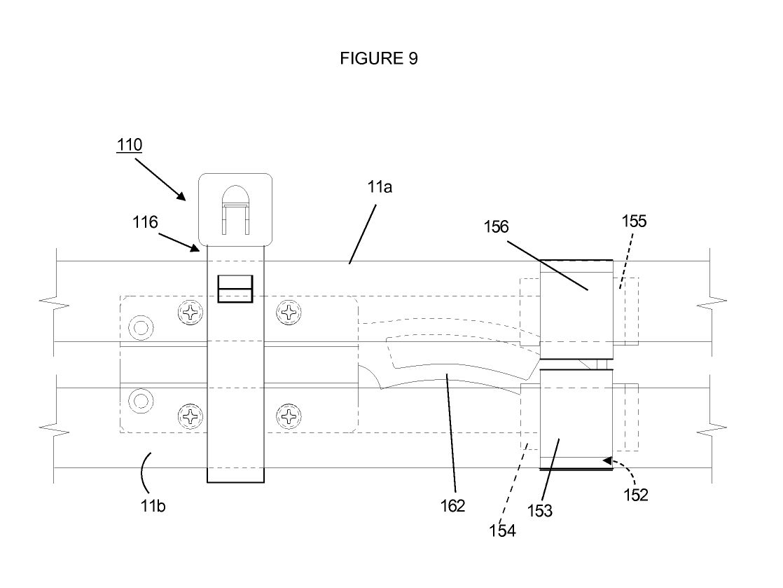

FIG. 9, in some ways similar to FIG. 8, shows the modular tool system 110 in a horizontal alignment on MOLLE-compatible webbing having belts 11a and 11b in which the carrying member 116 is attached or wrapped about a portion of the belt 11a. In this example, the tab assembly 152 is also connected to a portion of the belt 11b in a horizontal alignment to further conceal the handle 162 and to secure the system 110 to the belts 11a and 11b. Specifically, tab 156 is wrapped around belt 11a and magnetically engages tab 155. Tab 153 is wrapped around belt 11b and magnetically engages tab 154.

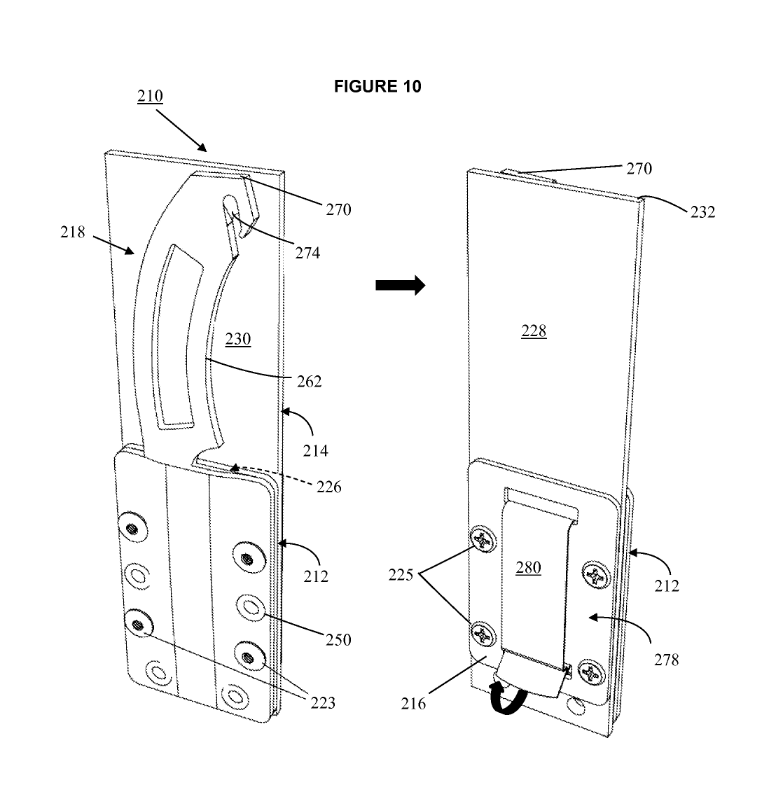

Turning now to FIG. 10, a modular tool holding system 210 is shown with a sheath member 212 mated to a sheath support or concealment member 214 by way of one or more connection members 225 via threaded screw posts 223. The tool 218 lies against an inner side 230 of the concealment member 214 and is relatively flat or thin to preferably not project beyond the rivets 250. The sheath member 212 may include additional receptacles for connection members such as eyelet rivets 250 for different configurations as desired. In addition, carrying member 216 comprises at least two holes adapted to align with two eyelet rivets 250 of the sheath member 212. Also shown in this example, a knife or cutting tool 218 is stored in a pocket or sleeve 226 formed in the sheath member 212. The tool 218 may include a handle 262 and a terminal end 270 that is relatively concealed by an end 232 of the concealment member 214 to hide the tool 218 from an outside viewpoint. The handle 262 also may include seatbelt cutter 274, which may be used to cut a seat-belt, for instance, of a trapped motorist.

Also shown in FIG. 10 by way of the bold, right facing arrow, a reverse side of the tool holding system 210 shows a carrying member 216 in the form of a clip system having a clip 280 affixed to a mounting piece 278. Here, the clip 280 has a spring constant whereby the clip can be bent or momentarily urged away from an outer side 228 of the concealment member 214 to removably affix the system 210 to, for instance, a police officer's tactical belt (not shown). Alternatively, the system 210 shown in FIG. 10 can be worn on a belt in a manner maximizing comfort rather than concealment. Side 228 would face the wearer's body, and would protect against end 270 from jabbing the wearer.

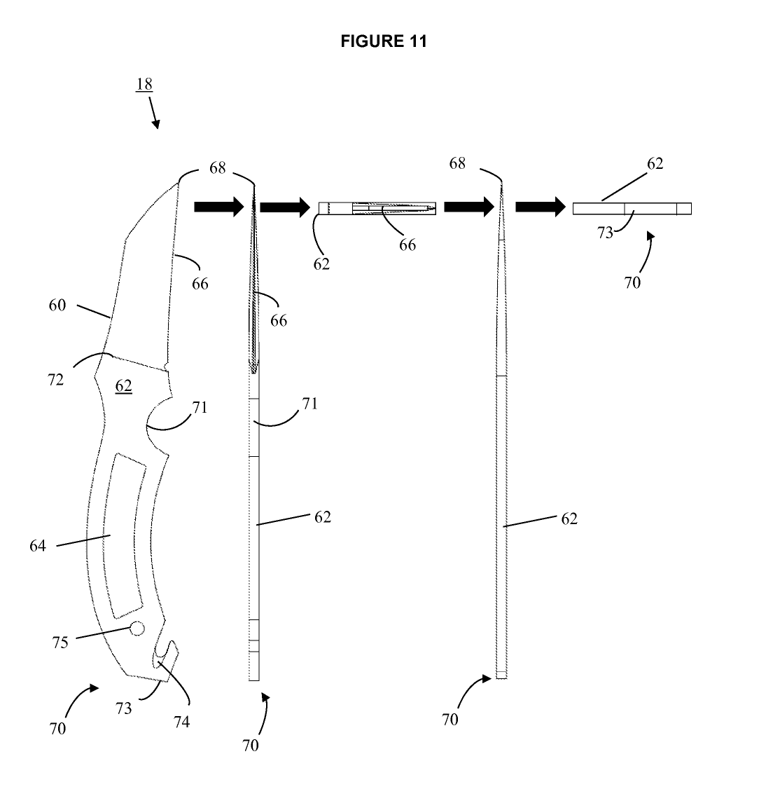

With reference to FIG. 11 the tool 18 discussed above is most clearly shown in elevational and end views beginning on the left side of FIG. 11 in a side elevational view then, as indicated by bold arrows, proceeding to the right to a blade end elevational view, a top down plan view, a rear elevational view and finally, a bottom up plan view. Here, the tool 18 includes the previously introduced blade 60 having edge 66 terminating in point 68. The tool 18 may include the handle 62 with the distal end 70 and the proximal end 72, which is mated to the blade 60. Also shown in FIG. 11, for ease of handling, the finger grip 71 may be located near the blade edge 66 in handle 62. Tool 18 also has a void 64 in handle 62. This void 64 saves weight, may add strength, and may function as a bottle cap opener. Lanyard hole 75 appears in handle 62. As noted above, this exemplary tool 18 may also include the glass breaker feature 73 located at the proximal end 70 along with the seatbelt cutter 74.

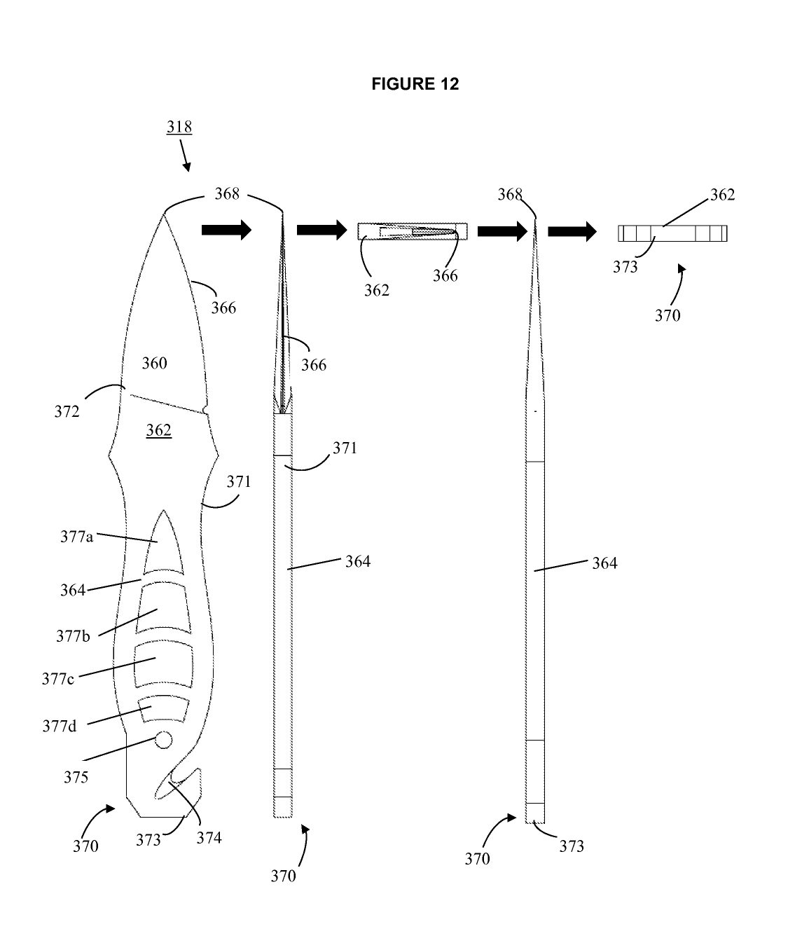

FIG. 12 shows a tool 318 according to another aspect of the disclosure. Here, the tool 318 has a blade 360 and is shown in elevational and end views. More specifically, beginning on the left side of FIG. 12 is a side elevational view of the tool 318. Proceeding to the right in FIG. 12, as indicated by bold arrows, is a blade end elevational view, a top down plan view, a rear elevational view and finally, a bottom up plan view. As shown, the tool 318 has a blade 360 with an edge 366 terminating in point 368. The tool 318 may include a handle 362 with a distal end 370 and a proximal end 372 mated to the blade 360. For handling ease, the finger gripping portion 371 may be located near the palm gripping surface 364 of handle 362. Handle 362 also includes voids 377a-377d and lanyard hole 375. This exemplary tool 318 may also include a hardened window breaking edge or feature 373 located at the proximal end 370. Also at the proximal end 370 a seatbelt cutter 374 may be provided. However, the disclosure is not limited to this exemplary arrangement. For instance, the seatbelt cutter 374 could be positioned elsewhere on the handle 362 to accommodate needs of different users.

### EMBODIMENTS

Embodiment 1. A system for carrying a bladed tool affixed to a person, comprising a sheath member, a concealment member, and a carrying member; wherein the sheath member, the concealment member, and the carrying member are adapted to be reversibly coupled by one or more connection members.

Embodiment 2. The system of embodiment 1, wherein the sheath member comprises a moldable thermoplastic, more particularly, an acrylic-polyvinyl chloride composite.

Embodiment 3. The system of any one of embodiments 1-2, wherein the sheath member comprises a plurality of eyelet rivets adapted to receive the one or more connection members.

Embodiment 4. The system of embodiment 3, wherein the plurality of eyelet rivets is disposed along an outer edge of the sheath member.

Embodiment 5. The system of any one of embodiments 1-4, wherein the sheath member substantially conforms to a shape of the bladed tool.

Embodiment 6. The system of any one of embodiments 1-5, wherein the concealment member comprises leather, nylon, or a combination thereof.

Embodiment 7. The system of embodiment 6, wherein the concealment member comprises 4 to 5 ounce leather.

Embodiment 8. The system of any one of embodiments 1-7, wherein the concealment member comprises leather having a surface pattern chosen from plain, basketweave, or a combination thereof.

Embodiment 9. The system of any one of the foregoing embodiments, wherein the concealment member has a substantially rectilinear form.

Embodiment 10. The system of any one of the foregoing embodiments, wherein the concealment member comprises two holes adapted to align with at least two eyelet rivets of the sheath member.

Embodiment 11. The system of any one of embodiments 1-3, wherein the carrying member comprises two holes adapted to align with at least two eyelet rivets of the sheath member.

Embodiment 12. The system of any one of the foregoing embodiments, wherein the carrying member comprises a belt clip affixed to a mounting piece.

Embodiment 13. The system of embodiment 12, wherein the mounting piece is rigid or flexible.

Embodiment 14. The system of any one of the foregoing embodiments, wherein the carrying member comprises a flexible strap comprising at least one reversible attachment device.

Embodiment 15. The system of embodiment 14, wherein the at least one reversible attachment device is chosen from snaps, buttons, hook-and-loop fabrics, magnets, modular attachment devices, and combinations thereof.

Embodiment 16. The system of any one of the foregoing embodiments, wherein the one or more connection members are chosen from screws, bolts with nuts, snaps, cord, hook and loop fabrics, and combinations thereof.

Embodiment 17. The system of any one of the foregoing embodiments, wherein the system is adapted to affix to a utility belt proximate a magazine pouch.

Embodiment 18. The system of any one of the foregoing embodiments, wherein the system is adapted to carry the bladed tool in a substantially vertical alignment.

Embodiment 19. The system of any one of the foregoing embodiments, wherein the system is adapted to carry the bladed tool in a substantially horizontal alignment.

Embodiment 20. The system of any one of the foregoing embodiments, wherein the concealment member is adapted to substantially conceal the bladed tool in a first configuration.

Embodiment 21. The system of any one of the foregoing embodiments, wherein the concealment member is adapted to separate the bladed tool from the body of the person in a second configuration.

Embodiment 22. The system of any one of the foregoing embodiments, wherein the bladed tool comprises a knife blade, a glass breaker, a seatbelt cutter, or a combination thereof.

Embodiment 23. The system of any one of the foregoing embodiments, wherein the system is adapted to affix to webbing adapted to carry modular lightweight load-carrying equipment.

Further embodiments of the present disclosure relate to a tool comprising a blade, a gripping portion, a glass breaker feature, a line cutter and combinations thereof. The tool preferably will be no thicker or wider than a sheath according to the disclosure.

As previously stated, detailed embodiments of the present invention are disclosed herein; however, it is to be understood that the disclosed embodiments are merely exemplary of the invention that may be embodied in various forms. It will be appreciated that many modifications and other variations stand within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

I claim:

1. A system for carrying a bladed tool affixed to a person, comprising:
a sheath member,
a concealment member, and
a carrying member;
wherein the sheath member, the concealment member, and the carrying member are adapted to be reversibly coupled by one or more connection members.

2. The system of claim 1, wherein the sheath member comprises a moldable thermoplastic.

3. The system of claim 2, wherein the moldable thermoplastic comprises an acrylic-polyvinyl chloride composite.

4. The system of claim 1, wherein the sheath member comprises a plurality of eyelet rivets adapted to receive the one or more connection members.

5. The system of claim 4, wherein the plurality of eyelet rivets is disposed along an outer edge of the sheath member.

6. The system of claim 1, wherein the sheath member substantially conforms to a shape of the bladed tool.

7. The system of claim 1, wherein the concealment member comprises leather, nylon, or a combination thereof.

8. The system of claim 7, wherein the concealment member comprises 4 to 5 ounce leather.

9. The system of claim 7, wherein the concealment member comprises leather having a surface pattern chosen from plain, basketweave, or a combination thereof.

10. The system of claim 1, wherein the concealment member has a substantially rectilinear form.

11. The system of claim 4, wherein the concealment member comprises two holes adapted to align with at least two eyelet rivets of the sheath member.

12. The system of claim 4, wherein the carrying member comprises two holes adapted to align with at least two eyelet rivets of the sheath member.

13. The system of claim 1, wherein the carrying member comprises a belt clip affixed to a mounting piece.

14. The system of claim 13, wherein the mounting piece is rigid.

15. The system of claim 13, wherein the mounting piece is flexible.

16. The system of claim 1, wherein the carrying member comprises a flexible strap comprising at least one reversible attachment device.

17. The system of claim 16, wherein the at least one reversible attachment device is chosen from snaps, buttons, hook-and-loop fabrics, magnets, modular attachment devices, and combinations thereof.

18. The system of claim 1, wherein the one or more connection members are chosen from screws, bolts with nuts, snaps, cord, hook and loop fabrics, and combinations thereof.

19. The system of claim 1, wherein the system is adapted to affix to a utility belt proximate a magazine pouch.

20. The system of claim 19, wherein the system is adapted to carry the bladed tool in a substantially vertical alignment.

21. The system of claim 19, wherein the system is adapted to carry the bladed tool in a substantially horizontal alignment.

22. The system of claim 1, wherein the concealment member is adapted to substantially conceal the bladed tool in a first configuration.

23. The system of claim 1, wherein the concealment member is adapted to separate the bladed tool from the body of the person in a second configuration.

24. The system of claim 1, wherein the bladed tool comprises a knife blade.

25. The system of claim 1, wherein the bladed tool comprises a glass breaker.

26. The system of claim 1, wherein the bladed tool comprises a seatbelt cutter.

27. The system of claim 1, wherein the system is adapted to affix to webbing adapted to carry modular lightweight load-carrying equipment.
